(19) United States
(12) Patent Application Publication
(10) Pub. No.: US 2005/0118908 A1
(43) Pub. Date: Jun. 2, 2005

(54) Rubber sheet with a clothed surface

(76) Inventor: Rong-Fen Chen, Taichung (TW)

Correspondence Address: Rong-Fen Chen, P.O. BOX 2103, Taichung, TW

(21) Appl. No.: 10/725,119

(22) Filed: Dec. 2, 2003

(51) Int. Cl. B32B 5/02

(52) U.S. Cl. 442/59

(57) ABSTRACT

A rubber sheet with a clothed surface includes a rubber layer and a cloth layer fully disposed on one side of the rubber layer. The cloth layer is previously printed with patterns. The rubber layer and the cloth layer are combined by thermal compression bonding. A waterproof layer is disposed on the cloth layer opposite to the rubber layer. The waterproof layer separates the cloth layer from water for preventing the cloth layer from containing water and assuring the adhering effect between the rubber layer and the cloth layer.

### BACKGROUND OF THE INVENTION

1. Field of the Invention

The present invention relates to a rubber sheet, and more particularly to a rubber sheet with a clothed surface that provides an adorning effect.

2. Description of Related Art

The rubber sheet is usually used as a material for waterproof shoes. For example, the rubber sheet is used in the periphery or the vamp of the shoes. For a good look, the shoes manufacturer usually prints the surface of the rubber sheet with printing ink to form a printed layer for beautifying the surface of the rubber sheet.

However, the printing layer may be gradually detached from the rubber sheet after used for a period of time so that the appearance of the rubber sheet becomes ugly.

For solving the above problem, some rubber sheet manufacturer adheres a cloth layer to the surface of the rubber sheet. The cloth layer is printed for promoting the vision effect of the rubber effect.

However, the cloth layer may contain water and the water contained in the cloth layer may influence on the glue for adhering the cloth layer to the rubber sheet. Consequently, the cloth layer may be detached from the rubber sheet.

The present invention has arisen to mitigate and/or obviate the disadvantages of the two conventional rubber sheets.

### SUMMARY OF THE INVENTION

The main objective of the present invention is to provide an improved rubber sheet with a clothed surface that provides an adorning effect.

To achieve the objective, the rubber sheet in accordance with the present invention comprises a rubber layer and a cloth layer fully disposed on one side of the rubber layer. The cloth layer is previously printed with patterns. The rubber layer and the cloth layer are combined by thermal compression bonding. A waterproof layer is disposed on the cloth layer opposite to the rubber layer. The waterproof layer separates the cloth layer from water for preventing the cloth layer from containing water and assuring the adhering effect between the rubber layer and the cloth layer.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a rubber sheet with a clothed surface in accordance with the present invention; and

FIG. 2 is a cross-sectional view of the rubber sheet in Fug. 1.

### DETAILED DESCRIPTION OF THE INVENTION

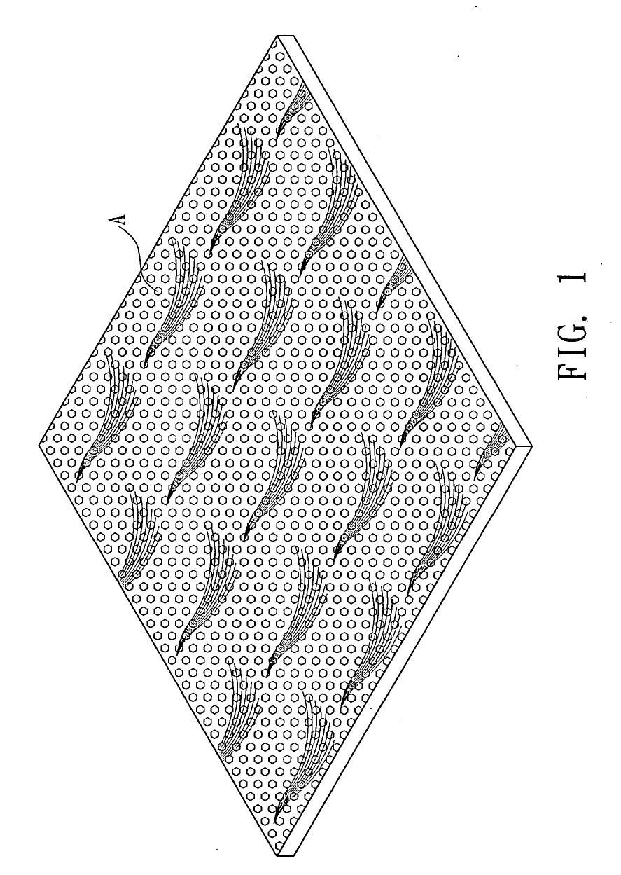

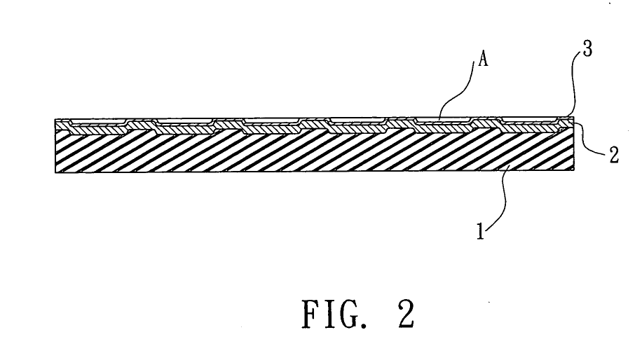

Referring to the drawings and initially to FIGS. 1 and 2, a rubber sheet in accordance with the present invention comprises a rubber layer (1) and a cloth layer (2) fully disposed on one side of the rubber layer (1). The cloth layer (2) is previously printed with patterns. A waterproof layer (3) is disposed on the cloth layer (2) opposite to the rubber layer (1). The rubber layer (1) and the cloth layer (2) are combined by thermal compression bonding for forming a series of grain (A) on the surface of the rubber sheet.

In the preferred embodiment of the present invention, the mold of thermal compression bonding having one side facing the rubber layer (1) is applied with waterproof agent so that the waterproof layer (3) is simultaneously formed in the thermal compression bonding process for prevent the previously printed pattern on the cloth layer (2) from being faded or detached in the thermal compression bonding process.

The waterproof layer (3) can separate the cloth layer (2) from water for preventing the cloth layer (2) from containing water and assuring the adhering effect between the rubber layer (1) and the cloth layer (2).

In addition, the series of grain (A) on the rubber sheet can increase the combining area between the cloth layer (2) and the rubber layer (1) for enhancing the connecting relation between the cloth layer (2) and the rubber layer (1) and the vision effect of the appearance of the rubber sheet in accordance with the present invention.

Although the invention has been explained in relation to its preferred embodiment, it is to be understood that many other possible modifications and variations can be made without departing from the spirit and scope of the invention as hereinafter claimed.

1. A rubber sheet with a clothed surface, comprising:
a rubber layer;
a cloth layer fully disposed on one side of the rubber layer, the cloth layer being previously printed with patterns, the rubber layer and the cloth layer being combined by thermal compression bonding; and
a waterproof layer being disposed on the cloth layer opposite to the rubber layer, the waterproof layer separating the cloth layer from water for preventing the cloth layer from containing water and assuring the adhering effect between the rubber layer and the cloth layer.

2. The rubber sheet as claimed in claim 1, wherein a series of grain is formed on the surface of the rubber sheet in the thermal compression bonding process for combining the rubber layer and the cloth layer.
